(19) United States
(12) Patent Application Publication
(10) Pub. No.: US 2007/0220732 A1
(43) Pub. Date: Sep. 27, 2007

(54) Flexible semi-rigid clothes dryer duct

(76) Inventor: Steven Liebson, Oudenaarde (BE)

Correspondence Address: Iandiorio & Teska, 260 Bear Hill Road, Waltham, MA, 02451-1018, US

(21) Appl. No.: 11/389,623

(22) Filed: Mar. 24, 2006

(51) Int. Cl. F16L 11/00; B23P 25/00

(52) U.S. Cl. 29/458; 138/133; 138/122; 138/134

(57) ABSTRACT

A semi-rigid, flexible, duct for gas transport and for clothes dryer exhaust transition, and a method for manufacture thereof, including a pair of coaxial sleeves, an inner sleeve and an outer sleeve disposed parallel to and about the inner sleeve, and a resilient helical element disposed between them; wherein each of the inner sleeve and the outer sleeve includes a first aluminum layer and a second polyester layer, wherein the helical element imparts helical corrugations to the sleeves such that the duct is axially extendible between a compacted configuration suitable for storage and shipping and an extended configuration suitable for installation in a gas transport arrangement, and wherein all the layers of the sleeves are of a thickness predetermined to together render the duct substantially rigid when in the extended configuration and to together enable the duct to maintain its substantial rigidity upon extension from the compacted configuration.

### FIELD OF THE INVENTION

The present invention relates generally to vents and ducts for gas transport and, more particularly, to ducts of the type commonly installed as exhaust transition ducts for household and commercial clothes dryers and as air ducts in heating, ventilation, and air conditioning (HVAC) systems.

### BACKGROUND OF THE INVENTION

Air ducts for ventilation systems are well known. They are typically used to direct air flow for heating and air conditioning systems. Another common application is for the exhaust vent of clothes dryers.

A very typical and common exhaust vent for clothes dryers is fabricated of a resilient wire helix which is covered with vinyl tubing, which lacks structural integrity and is generally not flame resistant or with aluminum tubing, which lacks structural integrity. The lack of structural integrity typically results in sagging and crinking of the duct. Ducts of these types also tend, over time, to become lined with lint from the clothes dried in the dryer, posing a fire hazard. According to the Consumer Products Safety Commission, there are over 15,000 fires annually associated with clothes dryers, causing deaths and injuries and some $90 million in damages. It is generally recommended by clothes dryer manufacturers not to use vinyl ducts such as these for dryer exhaust transition ducts.

Representative of the prior art in ventilation systems is U.S. Pat. No. 5,281,187, included herein by reference, to Whitney for a “Unitary Vent and Duct Assembly” which discloses a “semi-rigid flexible duct” for a ventilation system installed with a suspended ceiling structure. The duct taught in this patent is actually a solid aluminum tube which is corrugated or “accordion-folded” so that it can be compressed or compacted for storage or shipping. The corrugated aluminum tube duct taught therein, is meant to be coupled to a duct assembly of which it is an integral part, which is intended only for installation within a framed section of a suspended or dropped ceiling. However, once such a tube has been compressed and then re-extended for installation, it may not be likely to maintain its rigidity, depending on the thickness of the aluminum. A tube of this type that will maintain its rigidity, by virtue of its being fabricated of solid metal, will be heavy and expensive and can be unwieldy to install. The corrugated aluminum, when extended after compression, will have significant ridges and other obtrusive topographical features along its interior due to the corrugations, which will cause frictional resistance to the air flow within, a further disadvantage.

Corrugated aluminum is also employed for the exhaust vent of clothes dryers, as, for example, in U.S. Pat. Nos. 5,121,948, 5,133,579, and 5,145,217, which also solve the above-described problem of insufficient rigidity by using totally rigid segments. Even though the aluminum tubing itself is obviously fire resistant, the ridges and other internal topographical features similar to those mentioned hereinabove with respect to the Whitney patent, also cause fictional resistance to the air flow within, permitting accumulation of lint, which, as stated hereinabove, presents a fire hazard.

U.S. Pat. No. 5,526,849, included herein by reference, to Gray for a “Flexible Duct” discloses a duct and a method for manufacture thereof. The duct disclosed therein is formed of plastic tapes wound on a rotating mandrel with a wire resilient helix and a yarn helix therebetween. The duct so produced, while flame resistant, has rigidity limited to that provided by the wire helix. The additional yarn helix complicates the manufacturing process and adds to the internal topographical features of the duct, increasing friction and the possibility of lint accumulation therein, as described above.

### SUMMARY OF THE INVENTION

The present invention seeks to provide a flexible duct for a ventilation system, and particularly for clothes dryer exhaust, that is fire resistant and that is lighter in weight and less expensive than those used in the prior art, while maintaining rigidity and structural integrity, even after having been compressed to a compacted configuration for shipping and storage and then re-extended for installation. Further, the duct should have minimal internal topographical features or structure, even after having been compressed to a compacted configuration for shipping and storage and then re-extended for installation. The present invention further seeks to provide a method for manufacturing such a duct that is simple, fast, and efficient.

There is thus provided, a semi-rigid, flexible, duct for gas transport and in particular, to serve as a clothes dryer exhaust transition duct, having an axis, including a pair of coaxial sleeves, including an inner sleeve and an outer sleeve disposed parallel to and about the inner sleeve, and a resilient helical element disposed between them;
wherein each of the inner sleeve and the outer sleeve includes a first layer having metallic properties and one or both of which further include a second, plastic layer bonded to the first layer having metallic properties;
wherein the helical element imparts helical corrugations to the inner sleeve and the outer sleeve, such that the duct is axially extendible between a compacted configuration suitable for storage and for shipping and an extended configuration suitable for installation in a gas transport arrangement;
and wherein all the layers of both the inner sleeve and the outer sleeve are of a thickness predetermined to together render the duct substantially rigid when in the extended configuration and to together enable the duct to maintain its substantial rigidity upon extension from the compacted configuration.

When a predetermined length of the duct is in the extended configuration and is disposed horizontally and supported at a first end thereof, the duct is fabricated to bend under the influence of gravitational force such that a second unsupported end thereof is lower than the first supported end by no more than a predetermined percentage of the predetermined length. Further, when a predetermined length of the duct is in the extended configuration and is disposed horizontally and supported at both ends thereof, the duct is fabricated to bend under the influence of gravitational force such that the central portion thereof is also lower than the level of the supported ends by no more than a predetermined percentage of the predetermined length, which, for a 2 meter length of a duct with a diameter of approximately 10 centimeters, will be less than 1 centimeter for an extended duct that was not compacted and less than 5 centimeters for a duct that was extended from the compacted configuration. Additionally, when the duct is in the extended configuration after having been compressed to the compacted configuration, the inward-facing surface of the first layer having metallic properties of the inner sleeve is substantially smooth and featureless except for the helical corrugations.

Further, both the inner sleeve and the outer sleeve include a first layer having metallic properties and a second, plastic layer, forming thereby, respectively, an inner two-layer laminate and an outer two-layer laminate, which are fabricated of fire-resistant and puncture-resistant materials. In all of the two-layer laminates, the layers are bonded together with a fire-retardant adhesive and the inner two-layer laminate is also bonded to the outer two-layer laminate with a fire-retardant adhesive. Additionally, the first layers having metallic properties of the inner two-layer laminate and the outer two-layer laminate are fabricated of aluminum ribbon of predetermined thicknesses and the second, plastic layers of the inner two-layer laminate and the outer two-layer laminate are fabricated of polyester ribbon of predetermined thicknesses, respectively bonded together to form thereby, respectively, an inner two-layer laminated tape of predetermined thickness and an outer two-layer laminated tape of predetermined thickness, and wherein the inner two-layer laminate is an inner helical wrapping with a predetermined overlap of the inner two-layer laminated tape and the outer two-layer laminate is an outer helical wrapping with a predetermined overlap of the outer two-layer laminated tape. Further, in the inner sleeve, the second plastic layer is disposed parallel to and about the first layer having metallic properties and in the outer sleeve, the first layer having metallic properties is disposed parallel to and about the second plastic layer. The first layer having metallic properties of the inner two-layer laminate is fabricated of aluminum ribbon of a thickness in the range of 6 to 12 microns, and the first layer having metallic properties of the outer two-layer laminate is fabricated of aluminum ribbon of a thickness in the range of 24 to 35 microns. The second plastic layers of both the outer and inner two-layer laminates are fabricated of polyester ribbon of a thickness in the range of 10 to 14 microns.

Additionally, the resilient helical element is fabricated of a metal having spring-like resilience, such as a coiled bronze-coated steel wire of a diameter in the range of 0.9 to 1.3 millimeters.

Further, in accordance with a preferred embodiment of the invention, the resilient helical element is aligned with the inner helical wrapping so that the coiled bronze-coated steel wire is approximately centered over the overlap of the inner helical wrapping of the inner two-layer laminated tape and the outer helical wrapping of the outer two-layer laminated tape is aligned with the resilient helical element so that the overlap of the outer helical wrapping of the outer two-layer laminated tape is approximately centered over the spaces between the wires of the coiled bronze-coated steel wire of the resilient helical element.

In accordance with a further embodiment of the invention, the duct also includes an insulating sheath fabricated of fiberglass, disposed parallel to and about the outer sleeve, and an enclosing jacket disposed parallel thereto and thereabout. The enclosing jacket is a multi-layer jacket including a tubular, plastic inner wrapping and a two-layer laminate outer wrapping, including a plastic inner layer and an outer layer having metallic properties, bonded together with a fire-retardant adhesive, disposed parallel and about the tubular, plastic inner wrapping and bonded thereto with a fire-retardant adhesive. The plastic inner wrapping is fabricated of polyester ribbon of predetermined thickness, and the plastic inner layer of the two-layer laminate outer wrapping is fabricated of polyester ribbon of predetermined thickness and the outer layer having metallic properties of the two-layer laminate outer wrapping is fabricated of aluminum ribbon of predetermined thickness. The insulating sheath is fabricated of fiberglass of a thickness in the range of 25 to 50 millimeters. The plastic inner wrapping is fabricated of polyester ribbon of a thickness in the range of 10 to 14 microns. The plastic inner layer of the two-layer laminate outer wrapping is fabricated of polyester ribbon of a thickness in the range of 10 to 14 microns, and the outer layer having metallic properties of the two-layer laminate outer wrapping is fabricated of aluminum ribbon of a thickness in the range of 6 to 9 microns.

There is further provided, in accordance with the present invention, a method for manufacturing a semi-rigid, flexible, duct of a preselected diameter for gas transport, including the steps of:
a) providing a mandrel of preselected diameter for fabricating a duct therearound;
b) combining a first aluminum continuous ribbon of predetermined thickness in the range of 6 to 12 microns with a first polyester continuous ribbon of predetermined thickness in the range of 10 to 14 microns to form a first two-layer laminated continuous tape;
c) combining a second aluminum continuous ribbon of predetermined thickness in the range of 24 to 35 microns with a second polyester continuous ribbon of predetermined thickness in the range of 10 to 14 microns to form a second two-layer laminated continuous tape;
d) helically wrapping the first two-layer laminated continuous tape with a predetermined overlap around the mandrel with the first aluminum ribbon facing inward toward the mandrel and the first polyester ribbon facing outward with respect to the mandrel to form an inner two-layer sleeve;
e) helically coiling a bronze-coated steel wire of a thickness in the range of 0.9 to 1.3 millimeters around the inner two-layer sleeve; and
f) helically wrapping the second two-layer laminated continuous tape with a predetermined overlap around the inner two-layer sleeve and the bronze-coated steel wire coil with the second polyester ribbon facing inward toward the mandrel and the second aluminum ribbon facing outward with respect to the mandrel to form an outer two-layer sleeve disposed parallel to and about the inner two-layer sleeve.

Additionally, the step b) of combining a first aluminum ribbon includes the sub-step of applying a fire-retardant adhesive between the first aluminum ribbon and the first polyester ribbon to bond them together; and the step of c) combining a second aluminum ribbon includes the sub-step of applying a fire-retardant adhesive between the second aluminum ribbon and the second polyester ribbon to bond them together. Further, the step of b) combining a first aluminum ribbon further includes the sub-step of coating the polyester face of the first two-layer laminated continuous tape with a fire-retardant adhesive; the step c) of combining a second aluminum ribbon further includes the sub-step of coating the polyester face of the second two-layer laminated continuous tape with a fire-retardant adhesive; and in the step d) of helically wrapping the second two-layer laminated continuous tape, the outer two-layer sleeve is bonded to the inner two-layer sleeve with the bronze-coated steel wire helically coiled therebetween.

Additionally in accordance with the method of the present invention, the step e) of helically coiling a bronze-coated steel wire includes the sub-step of aligning the coiled wire with the overlap in the wrapping of the inner two-layer sleeve so that the coiled wire is approximately centered over the overlap in the wrapping of the inner two-layer sleeve, and the step f) of helically wrapping the second continuous two-layer laminated tape includes the sub-step of aligning the wrapping of the second continuous two-layer laminated tape so that the overlap in the wrapping of the outer two-layer sleeve is approximately centered over the spaces between the coils of wire.

Further in accordance with the method of the present invention, the steps d), e), and f) of helically wrapping the first two-layer laminated continuous tape, helically coiling the bronze-coated steel wire, and helically wrapping the second two-layer laminated continuous tape are performed by rotating the mandrel as the first two-layer laminated continuous tape, the bronze-coated steel wire, and the second two-layer laminated continuous tape are respectively deposited thereupon; and the steps d), e), and f) of helically wrapping the first two-layer laminated continuous tape, helically coiling the bronze-coated steel wire, and helically wrapping the second two-layer laminated continuous tape are performed continuously and simultaneously with predetermined phase differences, with respect to the rotation of the mandrel, therebetween. Namely, the steps d) and e) of helically wrapping the first two-layer laminated continuous tape and helically coiling the bronze-coated steel wire are performed continuously and simultaneously with a phase difference of 360 degrees, with respect to the rotation of the mandrel, therebetween; and the steps e) and f) of coiling the bronze-coated steel wire and helically wrapping the second two-layer laminated continuous tape are performed continuously and simultaneously with a phase difference of 120 degrees, with respect to the rotation of the mandrel, therebetween.

In accordance with an additional embodiment of the present invention, the method further includes, after the step f) of helically wrapping the second two-layer laminated tape, the steps of:
g) sheathing the outer two-layer sleeve with a fiberglass insulating sheath of a thickness in the range of 25 to 50 millimeters, disposed parallel thereto and thereabout; and
h) enveloping the insulating sheath with an enclosing jacket.
   Additionally, the step h) of enveloping includes the following sub-steps:

1) providing a mandrel of preselected diameter for fabricating the enclosing jacket therearound;
2) combining a polyester continuous ribbon of predetermined thickness in the range of 10 to 14 microns with an aluminum continuous ribbon of predetermined thickness in the range of 6 to 9 microns to form a two-layer laminated continuous tape;
3) helically wrapping a polyester continuous ribbon of predetermined thickness in the range of 10 to 14 microns around the mandrel to form an inner plastic sleeve; and
4) helically wrapping the two-layer laminated continuous tape around the inner plastic sleeve with the polyester ribbon facing inward toward the mandrel and the aluminum ribbon facing outward with respect to the mandrel to form an outer two-layer sleeve disposed parallel to and about the inner plastic sleeve.

The sub-step 2) of combining includes the sub-sub-step of applying a fire-retardant adhesive between the polyester ribbon and the aluminum ribbon to bond them together, and the sub-step 3) of helically wrapping a polyester ribbon includes the sub-sub-step of coating the outer face of the inner plastic sleeve with a fire-retardant adhesive to bond it to the two-layer laminated tape.

Additionally, the sub-steps 3) and 4) of helically wrapping a polyester ribbon and helically wrapping the two-layer laminated tape are performed by rotating the mandrel as the polyester ribbon and the two-layer laminated tape are respectively deposited thereupon. Further, the sub-steps 3) and 4) of helically wrapping a polyester ribbon and helically wrapping the two-layer laminated tape are performed continuously and simultaneously with a predetermined phase difference, namely, of 360 degrees, with respect to the rotation of the mandrel, therebetween.

### BRIEF DESCRIPTION OF THE DRAWINGS

The present invention will be more fully understood and appreciated from the following detailed description, taken in conjunction with the drawings, in which:

FIG. 1 is a side view of a segment of a duct, constructed and operative in accordance with an embodiment of the present invention;

FIG. 2 is a schematic axial cross-sectional view of the duct of FIG. 1;

FIG. 3 is a schematic oblique view of a segment of a duct that has been compressed;

FIG. 4 is a schematic oblique view of a duct similar to that shown in FIG. 1, further including an insulating sheath, constructed and operative in accordance with a further embodiment of the present invention;

FIG. 5 is a schematic axial cross-sectional view of the duct of FIG. 4;

FIG. 6 is a schematic view of a duct, constructed and operative in accordance with an embodiment of the present invention, which is installed as an exhaust transition duct of a clothes dryer;

FIG. 7 is a schematic axial view of a duct such as that of FIG. 1 being fabricated according to the method of the present invention;

FIG. 8 is an enlarged detailed schematic cross-sectional view of a portion of the wall of a duct such as that of FIG. 1;

FIG. 9 is a schematic axial view of an enclosing jacket such as that of FIG. 5 being fabricated according to the method of the present invention;

FIG. 10 is a schematic representation of the vertical sag of the unsupported center of a segment of duct such as that of FIG. 1 supported at its ends;

FIG. 11 is a schematic representation of the vertical displacement from the horizontal of the unsupported end of a segment of duct such as that of FIG. 1 supported at its other end; and

FIG. 12 is a schematic representation of the fabrication of an insulated duct such as that of FIG. 5.

### DETAILED DESCRIPTION OF THE INVENTION

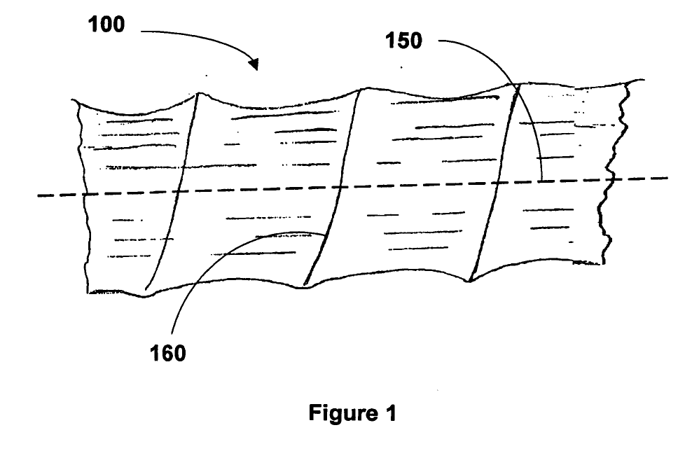

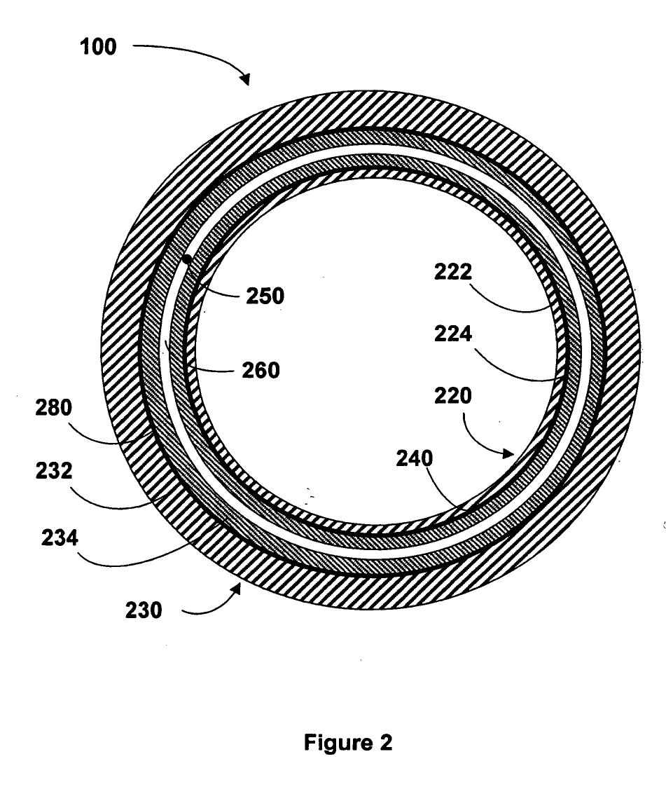

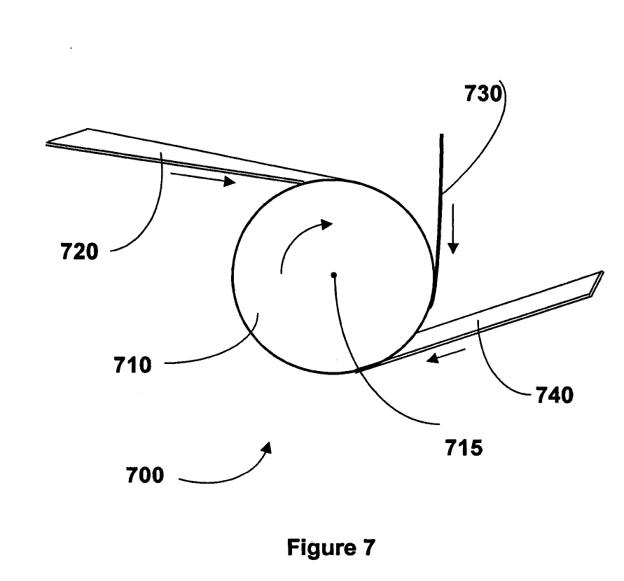

Referring now to the drawings, there are shown, in FIG. 1, a side view of a segment of a duct, referred to generally as 100, constructed and operative in accordance with a preferred embodiment of the present invention, and a schematic axial cross-sectional view thereof in FIG. 2. Duct 100, which is intended for use in a gas transport arrangement, is cylindrical, having an axis 150, and is of multi-layer construction, as shown in detail in FIG. 2. Duct 100 has inner and outer sleeves, referenced 220 and 230, respectively, which are coaxial and are of a laminate construction, each preferably being formed of a helical wrapping of a two-layer laminated tape formed of two layers of ribbon, 222, 224, and 232, 234, respectively, bonded together with an adhesive layer 240, 280. Inner sleeve 220 has an internal layer of aluminum ribbon 222 and an external layer of polyester ribbon 224 bonded together with adhesive layer 240 to form a two-layer laminated tape which is helically wrapped around a mandrel (710, see FIG. 7, discussed hereinbelow) to form inner sleeve 220. Coaxially coiled around inner sleeve 220 is a helical wire 250, preferably of bronze-coated steel, disposed and encapsulated between inner sleeve 220 and outer sleeve 230 with a layer of adhesive 260. Outer sleeve 230 is fabricated in a manner similar to inner sleeve 220, but wherein, the helically wrapped two-layer laminated tape has an internal layer of polyester ribbon 234 and an external layer of aluminum ribbon 232, bonded together with adhesive layer 280. The helically coiled bronze-coated steel wire 250 imparts helical corrugations 160 to duct 100, as can be seen in FIG. 1.

Polyester ribbon layers 224 and 234 are both heat resistant and fire retardant and further are made thick enough to contribute to the rigidity and structural integrity of duct 100 together with aluminum ribbon layers 222 and 232, which, being metallic, are fireproof as well. The adhesive employed in adhesive layers 240, 260, and 280 is also heat resistant and fire retardant. It should be noted that polyester ribbon layers 224 and 234 are also puncture resistant, which is a further advantage of the duct 100 of the present invention.

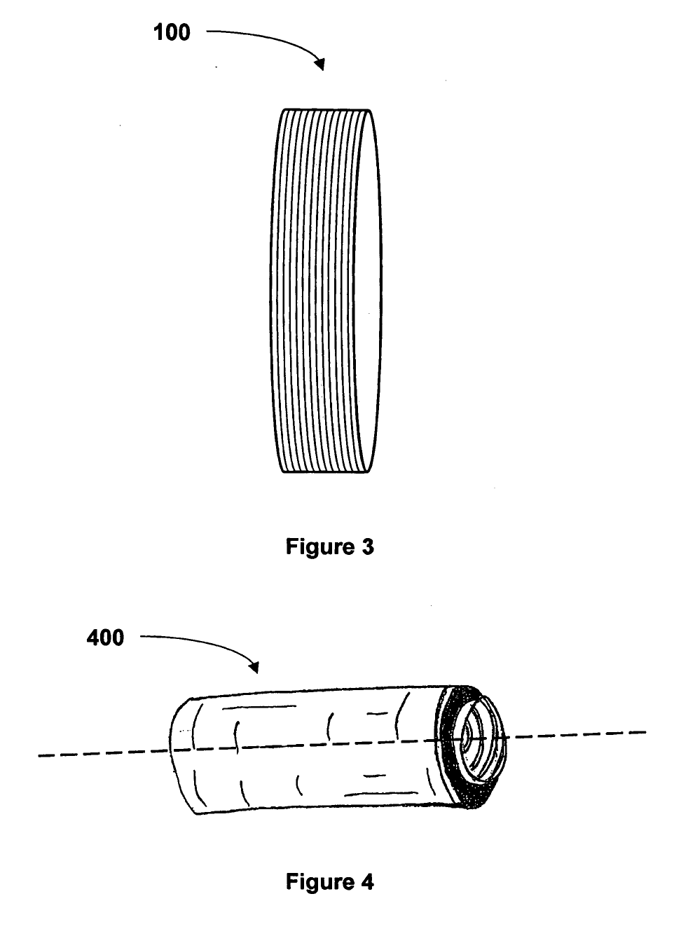

Duct 100 is manufactured fully extended by a continuous process, further described hereinbelow, and is then cut to a desired length. The corrugations 160 imparted thereto by helical wire 250 allow duct 100 to be axially compressed into a compact configuration convenient for storage or shipping. When duct 100 is compressed, as shown in FIG. 3, aluminum layers 222 and 232 and polyester layers 224 and 234 naturally fold between the ridges (referenced 160 in FIG. 1) created by helical wire 250. For example, a 2.4 meter length of 10 centimeter diameter duct fabricated in accordance with the present invention can be compressed to a length of approximately 15 centimeters, which is comparable to the compression of simple prior art ducts described hereinabove that do not have the advantages and improvements of the present invention.

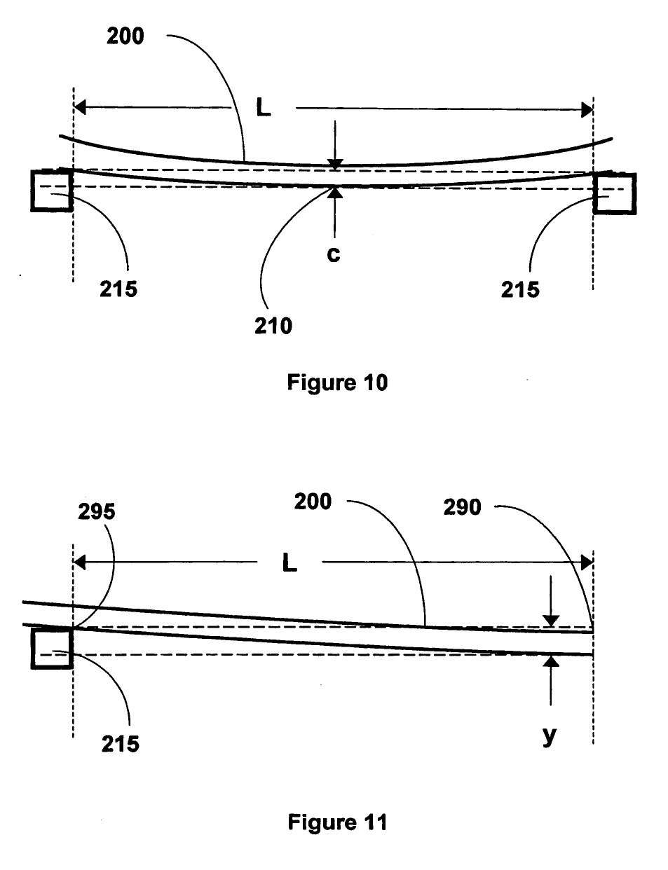

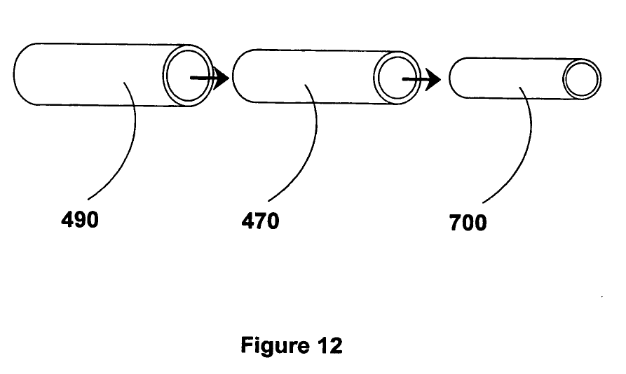

A particular advantage of the unique, multilayered construction of the present invention is that duct 100 maintains its rigidity and structural integrity and functions like a totally rigid duct even after having been compressed to its compact configuration and re-extended to its original length. Referring now to FIG. 10, there is shown, schematically, the vertical sag c of the unsupported center 210 of a horizontal segment of duct 200 spanning between two supports 215 a distance L apart. For example, for a length of duct that has been returned to its extended configuration after having been compressed, a 1.5 meter horizontal span of 10 centimeter diameter duct with no support in its center will substantially maintain its rigid shape and sag in the unsupported center by no more than 1 centimeter, while a similar 2 meter horizontal span of 10 centimeter diameter duct will sag in the unsupported center by no more than 5 centimeters. For a length of duct 100 that has not been compressed, a 1.5 meter horizontal span of 10 centimeter diameter duct that has no support in its center will maintain its rigid shape with negligible sag, while a 2 meter horizontal span of 10 centimeter diameter duct will sag in the unsupported center by no more than 1 centimeter. Referring now to FIG. 11, there is shown, schematically, the vertical displacement y from the horizontal of one unsupported end 290 of a horizontal segment of duct 200 of length L, as a result of bending due to gravity, when the other end 295 has support 215. Similarly, a vertically deployed segment of the duct of the present invention will maintain its rigidity, and not sag or collapse, even when returned to its extended configuration after having been compressed. As will be clear to those familiar with the art, these features represent a major improvement over the prior art, including solid aluminum corrugated tubes such as those employed in the invention of the Whitney patent (U.S. Pat. No. 5,281,187) discussed hereinabove.

Another advantage of the unique multilayered construction of the present invention is that when it is fully extended after compression, the inward-facing surface of the aluminum layer 222 of the inner sleeve 220 is substantially smooth and featureless except for the helical corrugations imparted by wire helix 250. This reduces frictional resistance to air flow within the duct, and, for clothes dryer exhaust transition ducts, significantly impedes the accumulation of lint inside the duct, thereby greatly reducing the fire hazard cited hereinabove with respect to the prior art.

Referring again to FIG. 2, in a preferred embodiment of the present invention in a typical product of the invention, duct 100 may have the following exemplary dimensions. The two-layer laminated tape of inner sleeve 220 has an inner aluminum ribbon layer 222 that is 7 microns thick and a polyester ribbon layer 224 that is 12 microns thick, so that, with the adhesive 240, inner sleeve 220 has a thickness of 21 microns. The wire helix 250 is 0.9 mm diameter bronze-coated steel wire. The two-layer laminated tape of outer sleeve 230 has an outer aluminum ribbon layer 232 that is 25 microns thick and a polyester ribbon layer 234 that is 12 microns thick, so that, with the adhesive 280, outer sleeve 230 has a thickness of 39 microns. The use of the thinner (7 microns) of aluminum ribbon layer 222 in inner sleeve 220 contributes to the above-mentioned smoothness of the inner surface of duct 100. It should be noted that the above-mentioned dimensions are typical and are exemplary of a preferred embodiment of the present invention, and that the present invention is not limited thereto. It should further be noted that, with suitable dimensions for the other layers of the duct of the present invention, either polyester layer 224 of inner sleeve 220 or polyester layer 234 of outer sleeve 230 may be omitted without loss of the improvements in rigidity of the present invention, albeit at a cost of additional thickness of aluminum, resulting in additional weight and expense. As such, either of these alternative configurations should be considered as being included in the present invention, as well as alternative dimensions of the layers that can still provide the desired performance of duct 100. Similarly, metallic layers or plastic layers fabricated of materials having properties comparable to those of the aluminum and polyester layers described hereinabove should also be considered as being included in the present invention.

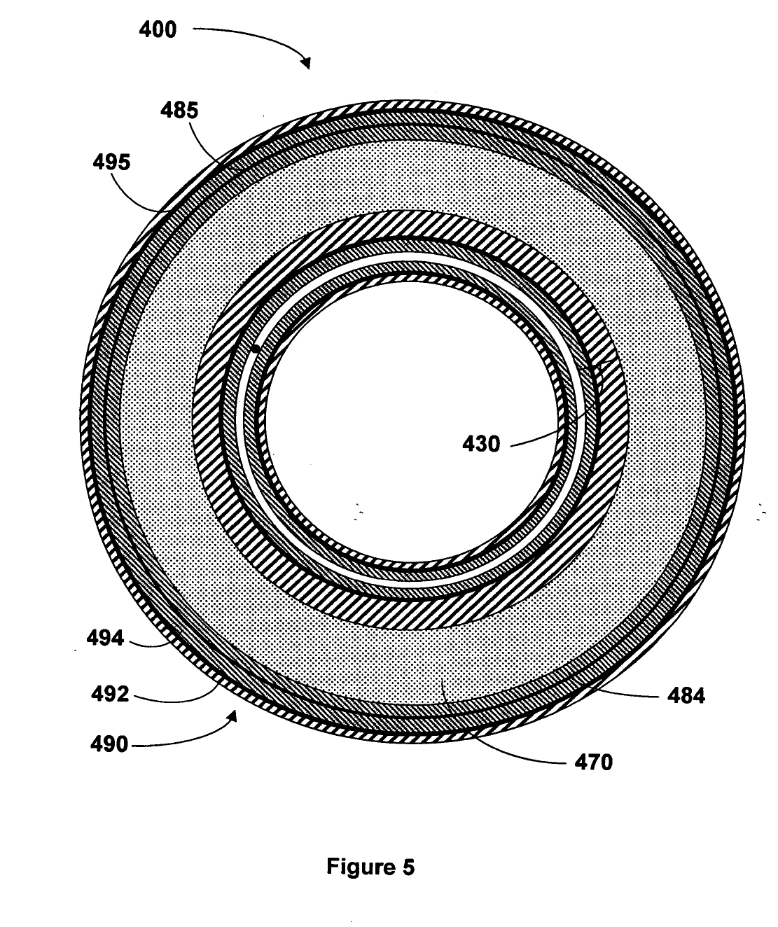

Referring now to FIG. 4. there is shown a schematic oblique view of a segment of a duct, referred to generally as 400, A schematic axial cross-sectional view of duct 400 is shown in FIG. 5. As shown in FIG. 5, duct 400 is similar to that shown in FIG. 1, but also includes an insulating layer 470 disposed parallel to and about outer sleeve 430 constructed and operative in accordance with a further preferred embodiment of the present invention. Additionally, insulating layer 470 has an enclosing jacket serving as a vapor barrier, referred to generally as 490, disposed thereabout. Insulating layer 470 is typically fabricated of fiberglass, which provides the desired insulation and is fire resistant. Enclosing jacket 490 is formed of an inner helical wrapping of polyester ribbon 484, bonded with a layer of heat and fire retardant adhesive 485 and an outer helical wrapping of a two-layer laminated tape having an inner layer of polyester ribbon 494 and an outer layer of aluminum ribbon 492 bonded together by a heat resistant and fire retardant adhesive 495.

In a preferred embodiment of the present invention, insulating layer 470 and enclosing jacket 490 of duct 400 have the following dimensions. Depending on the application, insulating layer 470 typically may be either 25 or 50 millimeters in thickness. The wrapping of polyester ribbon 484 is 12 microns thick. The two-layer laminated tape of the outer helical wrapping has an inner polyester ribbon layer 494 that is 12 microns thick and an outer aluminum ribbon layer 492 that is 7 microns thick, so that, with the adhesive 495, outer helical wrapping has a thickness of 21 microns. It should be noted that the above-mentioned dimensions are typical and are exemplary of a preferred embodiment of the present invention, and that the present invention is not limited thereto.

Enclosing jacket 490 is manufactured by a continuous process, similar to that of duct 100, and is then cut to a desired length. Duct 400 is assembled from an insulating layer 470 cut to the desired length and an enclosing jacket 490 cut to the desired length, which are drawn onto a segment of uninsulated duct, similar to duct 100, cut to the desired length.

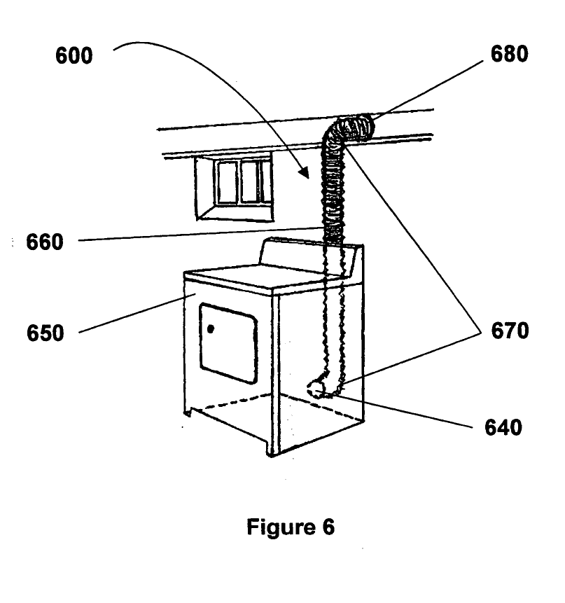

Referring now to FIG. 6, there is shown a schematic view of a duct 600, constructed and operative in accordance with an embodiment of the present invention, installed as an exhaust transition duct of a clothes dryer 650. Duct 600 is connected to dryer exhaust port 640 and has a vertical segment 660 and two right angle bends 670 connecting it to an outside exhaust port 680, thereby allowing it to vent the exhaust gases of clothes dryer 650. The features of the present invention discussed hereinabove, notably the rigidity and structural integrity and the reduced tendency to accumulate lint are particularly advantageous in applications such as this.

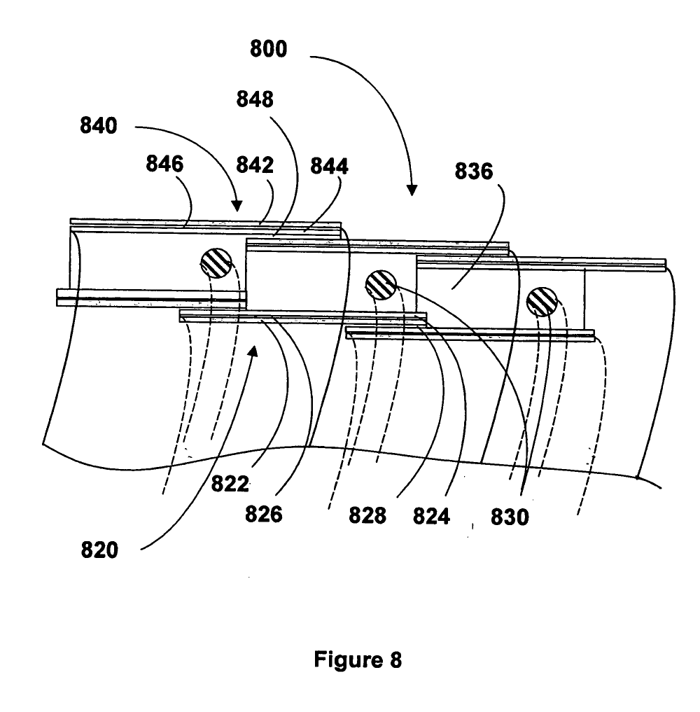

The advantageous properties of the duct of the present invention result both from its unique construction described hereinabove and from the method of manufacture thereof. Referring now to FIG. 7, there is shown a schematic axial view of a duct, referred to generally as 700, in accordance with the present invention being fabricated according to the method of the present invention. The size of the duct 700 being fabricated is determined by mandrel 710 which is rotated about its longitudinal axis 715. Inner two-layer laminate tape 720 is helically wrapped with a predetermined overlap 828 (FIG. 8) around mandrel 710 as it turns to produce the two-layer inner sleeve of duct 700 as a first step in forming duct 700. Bronzed-coated steel wire 730 is helically coiled around the two-layer inner sleeve of duct 700 as mandrel 710 turns with the two-layer inner sleeve formed thereupon. Outer two-layer laminate tape 740 is helically wrapped with a predetermined overlap 848 (FIG. 8) around the two-layer inner sleeve of duct 700 with bronzed-coated steel wire 730 coiled thereupon as mandrel 710 turns with the two-layer inner sleeve and the wire coil formed thereupon to produce the two-layer outer sleeve of duct 700.

Referring now to FIG. 8, there is shown an enlarged detailed schematic cross-sectional view of a portion of the wall of a duct, referred to generally as 800, constructed in accordance with the present invention, being fabricated according to the method of the present invention. Inner two-layer laminate tape, referred to generally as 820, is formed by combining an aluminum ribbon 822 with a polyester ribbon 824 by applying a fire-retardant adhesive 826 therebetween to bond them together. Similarly, outer two-layer laminate tape, referred to generally as 840, is formed by combining a polyester ribbon 844 with an aluminum ribbon 842 by applying a fire-retardant adhesive 846 therebetween to bond them together. It should be noted that inner two-layer laminate tape 820 and outer two-layer laminate tape 840 are both prepared prior to their being helically wrapped around mandrel 710 (FIG. 7) to fabricate duct 800, and that inner two-layer laminate tape 820 is wrapped around the mandrel with the aluminum ribbon 822 side inward toward the mandrel and outer two-layer laminate tape 840 is wrapped around the mandrel with the polyester ribbon 844 side inward toward the mandrel. It should further be noted that inner two-layer laminate tape 820 and outer two-layer laminate tape 840 are each respectively helically wrapped with a predetermined partial overlap, 828 and 848 respectively, so that successive wrappings produce continuous inner and outer two-layer sleeves. Additionally, it should be noted that the wires of wire coil 830 are aligned approximately centered above the overlap 828 in inner two-layer laminate tape 820, and the overlap 848 in outer two-layer laminate tape 840 is aligned approximately centered above the spaces between the wires of wire coil 830, which has been found to enhance the strength and rigidity of duct 800. Prior to inner two-layer laminate tape 820 and outer two-layer laminate tape 840 being helically wrapped around the mandrel to fabricate duct 800, the outer, polyester ribbon 824 side of inner two-layer laminate tape 820 and the inner, polyester ribbon 844 side of outer two-layer laminate tape 840 are coated with a fire-retardant adhesive, such as with a rolling adhesive applicator, thereby allowing them to be bonded together with an adhesive layer 836 which also encapsulates bronzed-coated steel wire coil 830 there between, when all are wound around mandrel 710 (FIG. 7) to fabricate duct 800.

Returning now to FIG. 7, it can be seen that both inner two-layer laminate tape 720 and outer two-layer laminate tape 740, as well as bronzed-coated steel wire 730, are all continuously and simultaneously wrapped and coiled, respectively, around mandrel 710 as it rotates. The wrappings and the coiling, while occurring simultaneously, are performed with predetermined phase differences, with respect to the rotation of mandrel 710, between them. Thus duct 700 is fabricated in one continuous operation. In an exemplary preferred embodiment of the present invention, the phase difference between the wrapping of inner two-layer laminate tape 720 and the coiling of bronzed-coated steel wire 730 is 360 degrees or one complete rotation of mandrel 710, and the phase difference between the coiling of bronzed-coated steel wire 730 and the wrapping of outer two-layer laminate tape 740 is 120 degrees or one third of a complete rotation of mandrel 710 about axis 715.

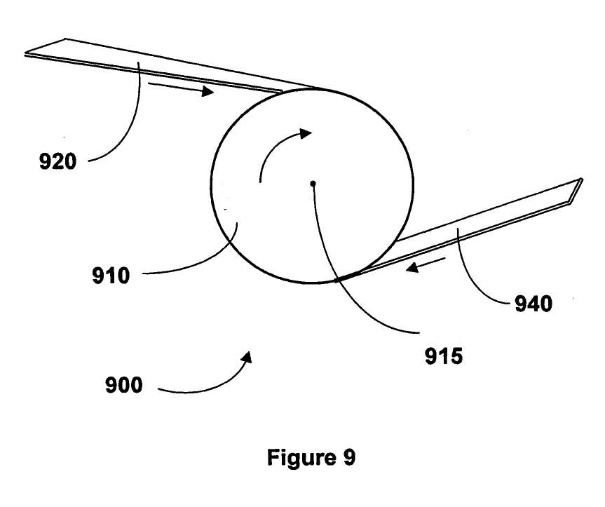

For the insulated duct 400 of FIGS. 4 and 5, enclosing jacket 490 is fabricated by a process analogous to that used to fabricate duct 700 described hereinabove. Referring now to FIG. 9, there is shown a schematic axial view of an enclosing jacket, referred to generally as 900, in accordance with the present invention being fabricated according to the method of the present invention. A two-layer laminate tape 940 with an inner polyester ribbon layer and an outer aluminum ribbon layer bonded with a fire-retardant adhesive is formed. A continuous inner plastic sleeve is produced by helically wrapping a polyester ribbon 920 around a rotating mandrel 910 of the desired diameter, and a continuous outer two-layer sleeve is produced by helically wrapping the two-layer laminate tape 940 around the inner plastic sleeve as the mandrel rotates, with a fire-retardant adhesive layer applied therebetween. Further as described hereinabove, enclosing jacket 900 is produced in one continuous operation, with continuous inner plastic sleeve and outer two-layer sleeve both wrapped around mandrel 910 continuously and simultaneously, with only a specific phase difference, with respect to the rotation of mandrel 910, between them. In a preferred embodiment of the present invention, the phase difference between the wrapping of the inner plastic sleeve and that of the outer two-layer sleeve is 360 degrees or one complete rotation of mandrel 910 about axis 915. In additional embodiments of the present invention, an additional tape of open-mesh laid fiberglass scrim may be wrapped between polyester ribbon 920 and two-layer laminate tape 940 in enclosing jacket 900 (not pictured).

To produce insulated duct 400, a piece of continuously produced uninsulated duct 700 is cut to the desired length, and a piece of continuously produced enclosing jacket 490 is cut to the desired length. As shown schematically in FIG. 12, the desired length piece of enclosing jacket 490, together with an insulating fiberglass sheath 470 of the desired length and suitable inner and outer diameters, are drawn over the desired length piece of uninsulated duct 700 to produce the insulated duct 400 shown in FIGS. 4 and 5.

It will further be appreciated by persons skilled in the art that the scope of the present invention is not limited by what has been specifically shown and described hereinabove, merely by way of example. Rather, the scope of the present invention is defined solely by the claims, which follow.

1. A semi-rigid, flexible, duct for gas transport, having an axis, including:
a pair of coaxial sleeves, including an inner sleeve and an outer sleeve disposed parallel to and about said inner sleeve; and
a resilient helical element disposed between said inner sleeve and said outer sleeve,
wherein each of said inner sleeve and said outer sleeve includes a first layer having metallic properties and at least one of said inner sleeve and said outer sleeve further includes a second, plastic layer bonded to said first layer;
wherein said helical element imparts helical corrugations to said inner sleeve and said outer sleeve, such that said duct is axially extendible between a compacted configuration suitable for storage and for shipping and an extended configuration suitable for installation in a gas transport arrangement;
and wherein all said layers of both said inner sleeve and said outer sleeve are of a thickness predetermined to together render said duct substantially rigid when in said extended configuration and to together enable said duct to maintain its substantial rigidity upon extension from said compacted configuration.

2. A duct according to claim 1, wherein both said inner sleeve and said outer sleeve include said second, plastic layer, forming thereby, respectively, an inner two-layer laminate and an outer two-layer laminate.

3. A duct according to claim 1, wherein, when a predetermined length L of said duct, of diameter d, is in the extended configuration and is disposed horizontally and supported at a first end thereof, said duct is operative to bend under the influence of gravitational force such that a second unsupported end thereof is lower than said first supported end by no more than y, such that (y/L)×100≦p, wherein p is a predetermined percentage of L.

4. A duct according to claim 1, wherein, when a predetermined length L of said duct, of diameter d, is in the extended configuration and is disposed horizontally and supported at both ends thereof, said duct is operative to bend under the influence of gravitational force such that the central portion thereof is lower than the level of said supported ends by no more than c, such that (c/L)×100≦q, wherein q is a predetermined percentage of L.

5. A duct according to claim 4, wherein, when L=2 meters and d=10 centimeters, c≦0.005L, and wherein, when said duct is in said extended configuration upon extension from said compacted configuration, c≦0.025L.

6. A duct according to claim 2, wherein both said inner two-layer laminate and said outer two-layer laminate are fabricated of fire-resistant materials and wherein said second, plastic layers of both said inner two-layer laminate and said outer two-layer laminate are fabricated of puncture-resistant materials.

7. A duct according to claim 2, wherein, said second, plastic layer of both said inner two-layer laminate and said outer two-layer laminate is bonded to said first layer thereof with a fire-retardant adhesive and said inner two-layer laminate is bonded to said outer two-layer laminate with a fire-retardant adhesive.

8. A duct according to claim 2, wherein said first layers of said inner two-layer laminate and said outer two-layer laminate are fabricated of aluminum ribbon of predetermined thicknesses and said second, plastic layers of said inner two-layer laminate and said outer two-layer laminate are fabricated of polyester ribbon of predetermined thicknesses, and wherein said aluminum ribbon of said inner two-layer laminate is bonded to said polyester ribbon to form an inner two-layer laminated tape of predetermined thickness, and said aluminum ribbon of said outer two-layer laminate is bonded to said polyester ribbon thereof so as to form an outer two-layer laminated tape of predetermined thickness, and wherein said inner two-layer laminate is an inner helical wrapping with a predetermined overlap of said inner two-layer laminated tape and said outer two-layer laminate is an outer helical wrapping with a predetermined overlap of said outer two-layer laminated tape.

9. A duct according to claim 1, wherein said resilient helical element is fabricated of a metal having spring-like resilience.

10. A duct according to claim 9, wherein said resilient helical element is a coiled bronze-coated steel wire.

11. A duct according to claim 10, wherein said resilient helical element is aligned with said inner helical wrapping so that said coiled bronze-coated steel wire is approximately centered over said overlap of said inner helical wrapping of said inner two-layer laminated tape and said outer helical wrapping of said outer two-layer laminated tape is aligned with said resilient helical element so that said overlap of said outer helical wrapping of said outer two-layer laminated tape is approximately centered over the spaces between said wires of said coiled bronze-coated steel wire of said resilient helical element.

12. A duct according to claim 2, wherein, said second plastic layer of said inner sleeve is disposed parallel to and about said first layer thereof; and said first layer of said outer sleeve is disposed parallel to and about said second plastic layer thereof.

13. A duct according to claim 2, wherein, when said duct is in said extended configuration after having been compressed to said compacted configuration, the inward-facing surface of said first layer having metallic properties of said inner sleeve is substantially smooth and featureless except for said helical corrugations.

14. A duct according to claim 1, further including an insulating sheath, disposed parallel to and about said outer sleeve, and an enclosing jacket disposed parallel to and about said insulating sheath.

15. A duct according to claim 14, wherein said insulating sheath is fabricated of fiberglass of a thickness in the range of 25 to 50 millimeters.

16. A duct according to claim 14, wherein said enclosing jacket is a multi-layer jacket including a tubular, plastic inner wrapping and a two-layer laminate outer wrapping disposed parallel thereto and thereabout and bonded thereto,
wherein said two-layer laminate outer wrapping includes a plastic inner layer and an outer layer having metallic properties, bonded together.

17. A duct according to claim 16, wherein said plastic inner wrapping is fabricated of polyester ribbon of predetermined thickness and wherein said plastic inner layer of said two-layer laminate outer wrapping is fabricated of polyester ribbon of predetermined thickness and said outer layer having metallic properties of said two-layer laminate outer wrapping is fabricated of aluminum ribbon of predetermined thickness.

18. A duct according to claim 17, wherein said tubular, plastic inner wrapping and said two-layer laminate outer wrapping are bonded together with a fire-retardant adhesive and wherein said polyester ribbon and said aluminum ribbon of said two-layer laminate outer wrapping are bonded together with a fire-retardant adhesive.

19. A duct according to claim 8, wherein:
said first layer having metallic properties of said inner two-layer laminate is fabricated of aluminum ribbon of a thickness in the range of 6 to 12 microns;
said first layer having metallic properties of said outer two-layer laminate is fabricated of aluminum ribbon of a thickness in the range of 24 to 35 microns;
said second plastic layer of said inner two-layer laminate is fabricated of polyester ribbon of a thickness in the range of 10 to 14 microns; and
said second plastic layer of said outer two-layer laminate is fabricated of polyester ribbon of a thickness in the range of 10 to 14 microns.

20. A duct according to claim 10, wherein said resilient helical element is fabricated of bronze-coated steel wire of a diameter in the range of 0.9 to 1.3 millimeters.

21. A duct according to claim 16, wherein said plastic inner wrapping is fabricated of polyester ribbon of a thickness in the range of 10 to 14 microns and said plastic inner layer of said two-layer laminate outer wrapping is fabricated of polyester ribbon of a thickness in the range of 10 to 14 microns and said outer layer having metallic properties of said two-layer laminate outer wrapping is fabricated of aluminum ribbon of a thickness in the range of 6 to 9 microns.

22. A duct according to claim 1, wherein said duct is a clothes dryer exhaust transition duct.

23. A method for manufacturing a semi-rigid, flexible, duct of a preselected diameter for gas transport, including the steps of:
a) providing a mandrel of preselected diameter for fabricating a duct therearound;
b) combining a first continuous aluminum ribbon of predetermined thickness with a first continuous polyester ribbon of predetermined thickness to form a first continuous two-layer laminated tape;
c) combining a second continuous aluminum ribbon of predetermined thickness with a second continuous polyester ribbon of predetermined thickness to form a second continuous two-layer laminated tape;
d) helically wrapping the first continuous two-layer laminated tape with a predetermined overlap around the mandrel with the first aluminum ribbon facing inward toward the mandrel and the first polyester ribbon facing outward with respect to the mandrel to form an inner two-layer sleeve;
e) helically coiling a wire around the inner two-layer sleeve; and
f) helically wrapping the second continuous two-layer laminated tape with a predetermined overlap around the inner two-layer sleeve and the wire coil with the second polyester ribbon facing inward toward the mandrel and the second aluminum ribbon facing outward with respect to the mandrel to form an outer two-layer sleeve disposed parallel to and about the inner two-layer sleeve.

24. A method according to claim 23, wherein said step b) of combining a first aluminum ribbon includes the sub-step of applying a fire-retardant adhesive between the first aluminum ribbon and the first polyester ribbon to bond them together; and wherein said step of c) combining a second aluminum ribbon includes the sub-step of applying a fire-retardant adhesive between the second aluminum ribbon and the second polyester ribbon to bond them together.

25. A method according to claim 23, wherein in said step f) of helically wrapping the second continuous two-layer laminated tape, the outer two-layer sleeve is bonded using a fire-retardant adhesive to the inner two-layer sleeve with the wire helically coiled therebetween.

26. A method according to claim 23, further including, after said step f) of helically wrapping the second two-layer laminated tape, the steps of:
g) sheathing the outer two-layer sleeve with a fiberglass insulating sheath, disposed parallel thereto and thereabout; and
h) enveloping the insulating sheath with an enclosing jacket.

27. A method according to claim 23, wherein said step e) of helically coiling a wire includes the sub-step of aligning the coiled wire with the overlap in the wrapping of the inner two-layer sleeve so that the coiled wire is approximately centered over the overlap in the wrapping of the inner two-layer sleeve, and wherein said step f) of helically wrapping the second continuous two-layer laminated tape includes the sub-step of aligning the wrapping of the second continuous two-layer laminated tape so that the overlap in the wrapping of the outer two-layer sleeve is approximately centered over the spaces between the coils of wire.

28. A method according to claim 23, wherein said step d) of helically wrapping the first continuous two-layer laminated tape, said step e) of helically coiling the wire, and said step f) of helically wrapping the second continuous two-layer laminated tape are performed by rotating the mandrel as the first continuous two-layer laminated tape, the wire, and the second continuous two-layer laminated tape are respectively taken up by the mandrel, continuously and with predetermined phase differences therebetween, with respect to the rotation of the mandrel.

29. A method according to claim 28, wherein said step d) of helically wrapping the first continuous two-layer laminated tape and said step e) of helically coiling the wire are performed continuously and with a phase difference of 360 degrees therebetween, with respect to the rotation of the mandrel; and wherein said step e) of helically coiling the wire and said step f) of helically wrapping the second continuous two-layer laminated tape are performed continuously and with a phase difference of 120 degrees therebetween, with respect to the rotation of the mandrel.

30. A method according to claim 23, wherein, in said step b) of combining a first continuous aluminum ribbon, the first continuous aluminum ribbon is of a thickness in the range of 6 to 12 microns and the first continuous polyester ribbon is of a thickness in the range of 10 to 14 microns; and wherein, in said step c) of combining a second continuous aluminum ribbon, the second continuous aluminum ribbon is of a thickness in the range of 24 to 35 microns and the second continuous polyester ribbon is of a thickness in the range of 10 to 14 microns; and wherein, in said step e) of helically coiling, the wire is a bronze-coated steel wire of a thickness in the range of 0.9 to 1.3 millimeters.

31. A method according to claim 26, wherein said step h) of enveloping includes the following sub-steps:
1) providing a mandrel of preselected diameter for fabricating the enclosing jacket therearound;
2) combining a continuous polyester ribbon of predetermined thickness with a continuous aluminum ribbon of predetermined thickness to form a continuous two-layer laminated tape;
3) helically wrapping a continuous polyester ribbon of predetermined thickness around the mandrel to form an inner plastic sleeve; and
4) helically wrapping the continuous two-layer laminated tape around the inner plastic sleeve with the polyester ribbon facing inward toward the mandrel and the aluminum ribbon facing outwardly with respect to the mandrel to form an outer two-layer sleeve disposed parallel to and about the inner plastic sleeve.

32. A method according to claim 31, wherein said sub-step 2) of combining includes the sub-sub-step of applying a fire-retardant adhesive between the polyester ribbon and the aluminum ribbon of the continuous two-layer laminated tape to bond them together.

33. A method according to claim 31, wherein said sub-step 3) of helically wrapping a polyester ribbon includes the sub-sub-step of coating the outer face of the inner plastic sleeve with a fire-retardant adhesive to bond it to the two-layer laminated tape.

34. A method according to claim 31, wherein said sub-step 3) of helically wrapping a polyester ribbon and said sub-step 4) of helically wrapping the two-layer laminated tape are performed by rotating the mandrel as the polyester ribbon and the two-layer laminated tape are respectively taken up by the mandrel, continuously and with a predetermined phase difference therebetween, with respect to the rotation of the mandrel.

35. A method according to claim 34, wherein said sub-steps 3) and 4) of helically wrapping a polyester ribbon and helically wrapping the two-layer laminated tape are performed continuously and with a phase difference of 360 degrees therebetween, with respect to the rotation of the mandrel.

36. A method according to claim 31, wherein, in said sub-step 3) of helically wrapping a continuous polyester ribbon, the polyester ribbon of the inner plastic sleeve is of a thickness in the range of 10 to 14 microns; and wherein, in said sub-step 2) of combining, the aluminum ribbon of the continuous two-layer laminated tape is of a thickness in the range of 10 to 14 microns and the aluminum ribbon of the continuous two-layer laminated tape is of a thickness in the range of 6 to 9 microns.
